(19) United States
(12) Patent Application Publication
(10) Pub. No.: US 2026/0014963 A1
(43) Pub. Date: Jan. 15, 2026

(54) Camera-Integrated Spray Nozzle

(71) Applicants: HYUNDAI MOTOR COMPANY, Seoul (KR); KIA CORPORATION, Seoul (KR); NIFCO KOREA Inc., Asan-si (KR); DY AUTO Corporation, Asan-si (KR)

(72) Inventors: Jong Min Park, Hwaseong-si (KR); Young Joo Cho, Hwaseong-si (KR); Kyeong Min Park, Asan-si (KR); Jae Hyoung Kim, Asan-si (KR); Sin Won Kang, Asan-si (KR); Gyu Seon Lee, Asan-si (KR)

(73) Assignees: HYUNDAI MOTOR COMPANY, Seoul (KR); KIA CORPORATION, Seoul (KR); NIFCO KOREA Inc., Asan-si (KR); DY AUTO Corporation, Asan-si (KR)

(21) Appl. No.: 18/959,377

(22) Filed: Nov. 25, 2024

(30) Foreign Application Priority Data
Jul. 10, 2024 (KR) 10-2024-0091197

(51) Int. Cl. B60S 1/56; G02B 27/00

(52) U.S. Cl. CPC B60S 1/56; G02B 27/0006

(57) ABSTRACT

Disclosed is a camera-integrated spray nozzle including a camera, a housing spaced apart from the camera, the housing including a first flow path configured to allow air to flow therethrough, a body inserted into the housing, the body including a second flow path configured to allow washer fluid to flow therethrough, and a discharge unit located at an end of the body, wherein the discharge unit includes a flow guide located at the housing and configured to determine a flow direction of the washer fluid and the air, a discharge guide configured to surround a discharge part of the second flow path, and a cover part located at the housing and configured to surround a discharge part of the first flow path and the discharge part of the second flow path.

### CROSS-REFERENCE TO RELATED APPLICATION

This application claims, under 35 U.S.C. § 119(a), the benefit of priority from Korean Patent Application No. 10-2024-0091197, filed on Jul. 10, 2024, the entire contents of which are incorporated herein by reference.

### TECHNICAL FIELD

The present disclosure relates to a camera-integrated spray nozzle, and more particularly, to a camera-integrated spray nozzle configured to simultaneously spray washer fluid and air for efficient cleaning of a sensor mounted on a vehicle.

### BACKGROUND

Recently, in order to ensure safe driving in various driving environments, a vehicle has a driver assistance system mounted therein and configured to assist a vehicle driver. In addition to the driver assistance system, research and development has been actively conducted on an autonomous vehicle capable of fulfilling main transportation capabilities of a conventional vehicle without intervention of a human driver. The driver assistance system and the autonomous vehicle require various types of environmental sensors capable of sensing the surrounding environment in various ways.

Examples of environmental sensors mounted in the vehicle include a radar, a LiDAR, a camera, and the like. Since the above-mentioned sensors are mounted on the outside of the vehicle, sensing portions of the sensors may be easily contaminated by foreign substances such as dust and dirt, rain, and snow depending on driving conditions such as climate, road conditions, and surrounding environments. When each sensor is contaminated by foreign substances, performance thereof may deteriorate. Here, in order to constantly maintain sensor performance, the sensors need to be kept clean to a certain degree. Therefore, a vehicle includes a contamination detection device configured to detect contamination of the sensors and a sensor cleaning system configured to clean the sensors when the sensing portions thereof are contaminated or stained.

In the case of a washer fluid cleaning method, when washer fluid is sprayed at a low temperature, discharge pressure of washer fluid having an increased viscosity is lowered, which may cause deterioration in cleaning performance of washer fluid. In order to solve this problem, research and development has been conducted on a nozzle configured to spray washer fluid therethrough to remove foreign substances and to simultaneously spray air and washer fluid respectively discharged from an air nozzle and a washer fluid nozzle.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a camera-integrated spray nozzle to efficiently clean a camera. More preferably, an object of the present disclosure is to efficiently remove foreign substances from a camera by providing a washer fluid flow path and an air flow path formed independently of each other and simultaneously spraying air and washer fluid respectively discharged from a washer fluid discharge part and an air discharge part.

The objects of the present disclosure are not limited to the above-mentioned objects, and other technical objects not mentioned herein will be clearly understood by those skilled in the art to which the present disclosure pertains from the detailed description of the embodiments. Additionally, the objects of the present disclosure may be achieved by means and combinations thereof as indicated in the claims.

In one aspect, the present disclosure provides a camera-integrated spray nozzle including a camera, a housing spaced apart from the camera, the housing including a first flow path configured to allow air to flow therethrough, a body inserted into the housing, the body including a second flow path configured to allow washer fluid to flow therethrough, and a discharge unit located at an end of the body, wherein the discharge unit includes a flow guide located at the housing and configured to determine a flow direction of the washer fluid and the air, a discharge guide configured to surround a discharge part of the second flow path, and a cover part located at the housing and configured to surround a discharge part of the first flow path and the discharge part of the second flow path.

In a preferred embodiment, the camera-integrated spray nozzle may further include a washer fluid connector coupled to the body and fluidly connected to the second flow path.

In another preferred embodiment, the discharge part of the first flow path may be formed at a position facing an upper surface of the discharge guide.

In still another preferred embodiment, the air discharged to the discharge part of the first flow path may flow along an outer surface of the discharge guide.

In yet another preferred embodiment, the camera-integrated spray nozzle may further include an air connector coupled to the housing and fluidly connected to the first flow path.

In still yet another preferred embodiment, the camera-integrated spray nozzle may further include a flange located on the body, and a guide groove formed in an inside surface of the housing and configured to allow the flange to be inserted thereinto.

In a further preferred embodiment, the housing having the discharge unit located therein may include a joint formed to extend along the second flow path, wherein the joint may have one open end facing the camera.

In another further preferred embodiment, the flow guide and the cover part may be located at the joint so as to face the camera.

In still another further preferred embodiment, the flow guide and the cover part may each be configured to have an inclination identical to an inclination of a shape of an end of the joint.

In yet another further preferred embodiment, the discharge guide may have an end located in contact with the housing.

In still yet another further preferred embodiment, the discharge part of the first flow path may be located in a space defined between the discharge guide and the housing.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a configuration example of a vehicle sensor cleaning system;

FIG. 2 is a view showing a schematic layout of sensors attached to a vehicle;

FIG. 3A is a perspective view showing a state in which a camera is assembled with a camera-integrated spray nozzle according to an embodiment of the present disclosure;

FIG. 3B is an exploded view of the camera-integrated spray nozzle according to the embodiment of the present disclosure;

FIG. 4 is a side view of the camera-integrated spray nozzle according to the embodiment of the present disclosure;

FIG. 5A shows a cross section taken along the line A-A in FIG. 4 according to the embodiment of the present disclosure;

FIG. 5B is an enlarged view of an air discharge part and a washer fluid discharge part of the camera-integrated spray nozzle according to the embodiment of the present disclosure;

FIG. 6A shows a cross section taken along the line B-B in FIG. 4 according to the embodiment of the present disclosure; and

FIG. 6B is an enlarged view showing a state in which a housing, a body, and a washer fluid connector are coupled to each other.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part” and “unit” described in the specification mean a unit configured to process at least two functions or operations, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

When a portion “comprises” or “includes” a certain component throughout the specification, this means that the portion may further comprise or include other components without excluding the other components unless stated otherwise.

A controller may be implemented by an algorithm configured to control the operation of various components disposed in a vehicle, a memory configured to store data about a program that reproduces the algorithm, and a processor configured to perform the above-described operation using data stored in the memory. In this case, the memory and the processor may be implemented as separate chips. Alternatively, the memory and the processor may be implemented as a single chip. For example, the controller may include at least two of an electronic control unit (ECU), a central processing unit (CPU), a microprocessor unit (MPU), a microcontroller unit (MCU), an application processor (AP), or any type of processor well known in the technical field of the present disclosure.

Furthermore, the controller may include at least two applications configured to execute a method according to the embodiments of the present disclosure, or the same may be formed of a combination of software capable of performing an arithmetic operation of a program and hardware.

Hereinafter, embodiments will be described in detail with reference to the accompanying drawings. In describing the embodiments with reference to the accompanying drawings, the same or corresponding components are denoted by the same reference numerals and overlapping descriptions thereof will be omitted.

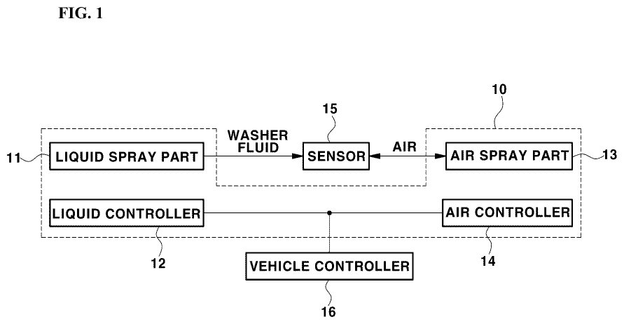

FIG. 1 is a view showing an example of an overall structure of a cleaning device for a vehicle sensor 15.

Referring to FIG. 1, the cleaning device for the vehicle sensor 15 includes a liquid spray part 11, a liquid controller 12, an air spray part 13, and an air controller 14. Further, the cleaning device for the vehicle sensor 15 may be connected to a vehicle controller 16. Additionally, each controller may be implemented with a microcontroller unit (MCU) or the like.

The liquid spray part 11 sprays washer fluid to a measurement area of the sensor 15. Components of washer fluid may vary depending on the embodiment. For example, washer fluid may be composed of plain water or the same ingredients as those used for vehicle glass.

Additionally, the liquid spray part 11 may spray washer fluid to a plurality of sensors 15 simultaneously or sequentially or may spray washer fluid only to the sensor 15 that needs to be cleaned.

In addition, the liquid controller 12 receives a cleaning request from the vehicle controller 16 and controls the liquid spray part 11 through which washer fluid is sprayed. When cleaning request signals for a plurality of sensors 15 are received, washer fluid may be sprayed sequentially or simultaneously.

Additionally, the air spray part 13 sprays air stored in the vehicle to a measurement area of the sensor 15. Since the plurality of sensors 15 are provided in the vehicle, the air spray part 13 may spray air to the plurality of sensors 15 simultaneously or sequentially, or may spray air only to the sensor 15 that needs to be cleaned. The air sprayed to the sensor 15 may be general air or compressed air. Additionally, the air controller 14 receives a cleaning request from the vehicle controller 16 and controls the air spray part 13 through which air is sprayed.

According to the embodiment, the cleaning device for the vehicle sensor 15 receives the cleaning request from the vehicle controller 16 and cleans the sensor by spraying washer fluid and air. Here, washer fluid and air may be sprayed alternately in an intersecting manner to efficiently clean the sensor 15.

In addition, high-pressure air is sprayed through the air spray part 13, and the air spray part 13 may be formed of a compressor, an air tank, an air distributor, and a plurality of nozzles. Further, high-pressure air is compressed by a compressor and is stored in an air tank, and air pressure is adjustable through the compressor.

Furthermore, compressed air output from the air tank may be distributed to a plurality of nozzles through an air distributor. In this case, high-pressure air may be sprayed to each sensor 15 through a nozzle.

Moreover, the air distributor turns on/off each channel under the control of the air controller 14. For example, when the air distributor receives an ON command for a first channel from the air controller 14, the air distributor outputs compressed air from the air tank through the first channel, and a first nozzle connected to the first channel through an air hose sprays air to the first sensor 15. ON/OFF of the channel may be controlled through a solenoid valve or the like.

Additionally, the liquid spray part 11 is operated in the same manner as that of the air spray part 13. Washer fluid is pressurized through a washer fluid pump and is stored in a washer fluid tank. Here, the stored washer fluid may be sprayed to the sensor 15 through a nozzle when necessary.

Hereinafter, according to the present disclosure, a spray relationship between washer fluid and air will be described with reference to a cleaning device that cleans a camera 100 among sensors.

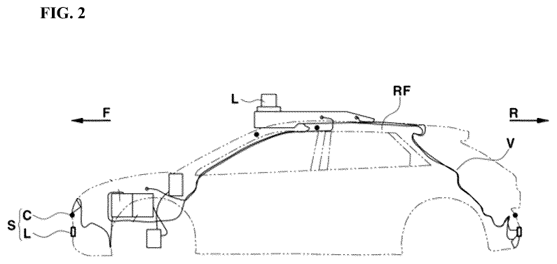

FIG. 2 is view showing a schematic layout of sensors attached to a vehicle.

An autonomous vehicle or a vehicle equipped with a driver assistance system has various types of sensors mounted therein and configured to detect a surrounding environment. As a non-limiting example, the sensors include a LiDAR system, a radar system, the camera 100, and the like. Here, the sensors may be disposed on a front portion, a rear portion, a side portion, a roof portion, and the like of the vehicle.

As an example, FIG. 2 is a view showing arrangement of a LiDAR L and the camera C (the camera 100) among sensors S. The LiDARs L may be respectively disposed on a roof RF, a front F, and a rear R of a vehicle V, and one or more cameras C (one or more cameras 100) may be respectively disposed on the front F, the rear R, the roof RF, and the side of the vehicle V. In particular, as the level of autonomous driving increases, the number of sensors S mounted on the vehicle V is increasing.

Further, among the sensors, the camera 100 is configured to detect a wide-angle external image, and the image detected by the camera 100 is analyzed in an autonomous driving system. When the surface of the camera 100 is contaminated, the external shape may be distorted, and accurate image analysis may not be appropriately performed. Therefore, it is very important to keep the surface of the camera 100 clean so as to enable the camera 100 to sense an external shape with high clarity and provide an image thereof.

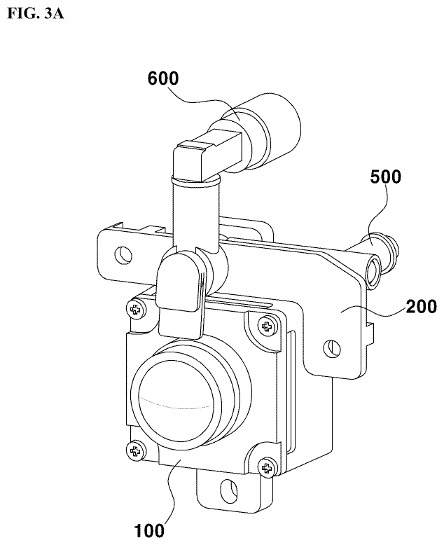

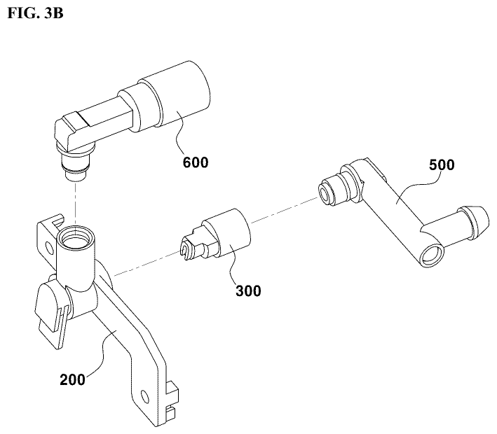

FIG. 3A is a perspective view showing a state in which the camera 100 is assembled with a camera-integrated spray nozzle.

According to the embodiment of the present disclosure, the camera-integrated spray nozzle may include a housing 200 disposed spaced apart from the camera 100, a body 300 coupled to the housing 200, a washer fluid connector 500 coupled to the body 300, an air connector 600 coupled to the upper end of the housing 200, and a discharge unit 400 through which washer fluid is discharged.

Additionally, the camera 100 may include a main body, a cover coupled to the front of the main body, and a sensor part located at the center of the cover. More preferably, the main body may have a rectangular parallelepiped shape, and the cover of the camera 100 may have the same shape as that of the main body. Furthermore, the sensor part may be located at the exact center of the cover of the camera 100.

Additionally, the housing 200 may include a support spaced apart from the main body of the camera 100 and fixed to a vehicle body and a main body coupled to the support. More preferably, the main body of the housing 200 may include a guide groove 260 into which the body 300 is inserted, an air slot into which the air connector 600 is inserted, and a first flow path 210 through which air flows.

Moreover, the support may be located on the upper side of the main body of the camera 100. More preferably, the support may be configured to be perpendicular to the upper surface of the main body of the camera 100 and to be perpendicular to the right side of the main body of the camera 100. More preferably, the support may be formed in an ‘L’ shape. More preferably, a support portion located on the right side of the main body of the camera 100 may be manufactured to have a relatively shorter length than a support portion located on the upper side of the main body of the camera 100.

Additionally, the main body of the housing 200 may be located on the support portion located on the upper side of the main body of the camera 100. Here, the main body of the housing 200 may be located corresponding to the position of the sensor part of the camera 100. More preferably, the main body of the housing 200 may be located above the center of the upper end of the cover of the camera 100 when the sensor part of the camera 100 is located at the (e.g., exact) center of the cover of the camera 100.

Here, the front of the main body of the housing 200 may refer to the same direction as the front of the camera 100, and the rear of the main body of the housing 200 may refer to the same direction as the rear of the camera 100.

Additionally, the housing 200 may include an opening, and the main body of the housing 200 may be located adjacent to the opening. In addition, the housing 200 may include a joint 240 formed to extend outwards and disposed to surround the opening of the housing 200. Moreover, since the joint 240 has an open lower end through a flow guide 230 and a cover part 250, air and washer fluid are sprayed into the opening of the housing 200 through the configuration of the joint 240, the flow guide 230, and the cover part 250 and are further sprayed to an area facing the lens of the camera 100 through the open lower end.

More specifically, the housing 200 may include, on the front of the main body thereof, the joint 240 having one open end facing the camera 100, the flow guide 230 located adjacent to the joint 240 and configured to determine a fluid flow direction, and the cover part 250 located adjacent to the joint 240. Furthermore, the flow guide 230 and the cover part 250 may be configured to extend in a direction facing the camera 100.

Additionally, the joint 240 may be located to extend to the outside of the housing 200 along the opening in a direction in which the body 300 is inserted into the housing 200. Furthermore, the flow guide 230 may be located at the lower end of the joint 240, and the cover part 250 may be located at the front of the joint 240.

Additionally, the housing 200 may include the guide groove 260 formed in the inside surface of the main body thereof and configured to allow the body 300 to be inserted thereinto. Further, the body 300 may include a flange 330 inserted into the guide groove 260 and a washer fluid slot into which the washer fluid connector 500 is inserted. Furthermore, the flange 330 may include a second flow path 310 formed on the inside thereof and configured to allow washer fluid to flow therethrough. Further, the flange 330 may include a discharge guide 410 formed at the end thereof and configured to surround a second flow path discharge part 320. Here, the second flow path discharge part 320 may mean a washer fluid discharge part. Furthermore, the second flow path 310 may mean a washer fluid flow path through which the washer fluid flows. More preferably, the washer fluid connector 500 is inserted into the washer fluid slot so that the washer fluid flow path may be fluidly connected to the washer fluid connector 500.

Furthermore, the discharge guide 410 may be formed to have one end that is open in a direction facing the camera 100. Through this structural configuration, washer fluid discharged from the washer fluid discharge part may be sprayed in the direction facing the camera 100.

Additionally, the housing 200 is configured to include the first flow path 210 formed therein. The first flow path 210 may mean an air flow path through which air flows. Furthermore, the air connector 600 is connected to the air slot located at the upper end of the main body of the housing 200, thereby making it possible to be fluidly connected to the air flow path.

Moreover, before the body 300 is inserted into the housing 200, air flowing through the air flow path may be discharged from the upper end of the housing 200 in the direction facing the camera 100 and in a direction of the rear of the main body of the housing 200 through the guide groove 260. More preferably, air introduced into the air connector 600 may be discharged in the direction facing the camera 100 and in the direction of the rear of the main body of the housing 200.

Furthermore, when the body 300 is inserted into the housing 200, an area through which air is discharged in the direction of the rear of the main body of the housing 200 may be closed. More preferably, since the area through which air is discharged in the direction of the rear of the main body of the housing 200 is closed, air flowing through the air flow path may flow through a space in which the housing 200 and the body 300 do not contact each other. Additionally, air may be discharged from the upper end of the main body of the housing 200 only in the direction facing the camera 100. That is, when the body 300 is inserted into the housing 200, air may be discharged (e.g., only) in the direction facing the camera 100.

Additionally, the air flow path may be configured to include the inside of the air slot perpendicular to the main body and the upper side of the discharge guide 410. Moreover, the air flow path may be located perpendicular to the washer fluid flow path. Additionally, since the washer fluid flow path is provided on the inside of the body 300, the washer fluid flow path and the air flow path may be separated independently of each other. Air and washer fluid may be simultaneously or selectively sprayed in a direction facing the sensor part of the camera 100 through the first flow path discharge part 220 through which air is discharged and the second flow path discharge part 320 through which washer fluid is discharged.

Additionally, the discharge unit 400 may be configured to spray, in the direction facing the camera 100, the air discharged from the air discharge part and the washer fluid discharged from the washer fluid discharge part. Furthermore, the discharge unit 400 may include the discharge guide 410, the flow guide 230, and the cover part 250. The flow guide 230 may be configured to determine a flow direction of washer fluid. More preferably, the flow guide 230 may serve to guide the washer fluid to flow in the direction facing the camera 100. Additionally, the cover part 250 may be configured to surround the air discharge part and the washer fluid discharge part. Furthermore, the cover part 250 may be disposed to contact a part of the joint 240. Additionally, the joint 240 may extend along the washer fluid flow path and may be formed to be partially open in the direction facing the camera 100. More preferably, the joint 240 may be formed in a semicircular shape open in the direction facing the camera 100.

More preferably, air discharged from the air discharge part flows in opposite directions along opposite sides of the discharge guide 410. In this case, air flows to the flow guide 230 through the open end of the joint 240. Accordingly, the air flowing to the flow guide 230 may be sprayed in the direction facing the camera 100 along the flow guide 230. Here, washer fluid discharged from the washer fluid discharge part flows to the flow guide 230 through the open end of the discharge guide 410. In this case, the washer fluid flowing to the flow guide 230 may be sprayed in the direction facing the camera 100 along the flow guide 230.

Further, the washer fluid discharged through the open end of the discharge guide 410 meets the air discharged along the opposite sides of the discharge guide 410 at the open end of the joint 240, thereby increasing pressure of the washer fluid.

FIG. 3B shows an exploded view of the camera-integrated spray nozzle.

According to the embodiment of the present disclosure, the air connector 600 may include an air coupling part coupled to the air slot and an air inlet part through which high-pressure air is introduced. A portion extending from the air inlet part may be configured to be perpendicular to the air coupling part. More preferably, when the air coupling part is inserted into the air slot, the air inlet part may be located to face the same direction as the rear of the housing 200. Furthermore, the air coupling part may be inserted into the air slot so as to be fluidly connected to the air flow path.

Further, according to the above-described positional relationship, air introduced into the air connector 600 flows in a direction perpendicular to the upper end of the main body, air introduced into the upper end of the main body is discharged through the air discharge part, and the air discharged through the air discharge part is sprayed in the direction facing the camera 100 along the flow guide 230, thereby preventing a vortex of the air.

Additionally, the body 300 may include the flange 330 inserted into the guide groove 260 and the washer fluid slot into which the washer fluid connector 500 is coupled. Furthermore, a portion of the flange 330, which is inserted into the guide groove 260, may include the discharge guide 410. Moreover, the upper surface of the flange 330 may be configured to be parallel to the upper surface of the camera 100. Through the shape of the flange 330, the body 300 is fixed to the housing 200, thereby preventing rotation of the discharge guide 410. More preferably, washer fluid discharged from the washer fluid discharge part may be uniformly sprayed in the direction facing the camera 100 by preventing the open end of the discharge guide 410 from being rotated relative to the housing 200.

Additionally, the washer fluid connector 500 may be inserted into the washer fluid slot. Furthermore, when the washer fluid connector 500 is inserted into the washer fluid slot, the washer fluid flow path and the inside of the washer fluid connector 500 may be fluidly connected to each other.

Here, washer fluid introduced into the washer fluid connector 500 flows to the washer fluid discharge part through the washer fluid flow path, and the washer fluid discharged from the washer fluid discharge part may be sprayed in the direction facing the camera 100 along the flow guide 230. Furthermore, the end of the washer fluid connector 500 may be bent in a direction perpendicular to the washer fluid slot. In this manner, the washer fluid connector 500 is assembled with the washer fluid slot in a direction consistent with the flow guide 230.

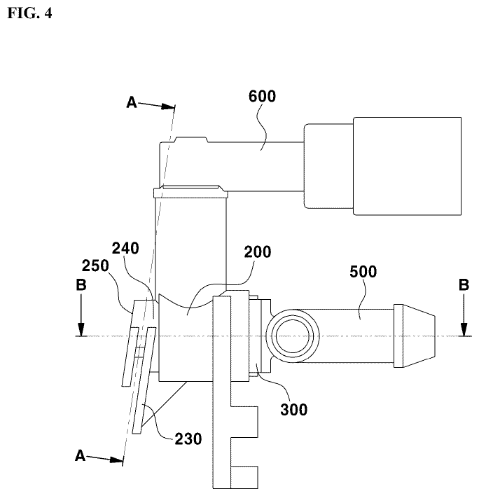

FIG. 4 is a side view of the camera-integrated spray nozzle.

According to the embodiment of the present disclosure, when the air connector 600, the body 300, and the washer fluid connector 500 are coupled to the housing 200, and the coupled state is viewed from the side, the air slot and the air connector 600 may be perpendicular to each other, and the air slot and an extension line of the washer fluid connector 500 may be perpendicular to each other, thereby preferably forming a “C” shape.

In addition, the cover part 250 may be located on the front of the housing 200, the joint 240 may be located adjacent to the cover part 250, and the flow guide 230 may be located at the joint 240. More preferably, the flow guide 230 may be located adjacent to the camera 100.

Additionally, the flow guide 230 may be configured to determine the fluid flow direction. Moreover, the flow guide 230 may be configured to have a predetermined angle in the height direction thereof relative to the cover of the camera 100, thereby solving a problem in which washer fluid is not sprayed over a wide area when the viscous washer fluid is sprayed directly toward the camera 100.

More preferably, when the flow guide 230 is configured to have the predetermined angle as described above, washer fluid discharged from the washer fluid discharge part is not sprayed directly toward the camera 100, but is sprayed in the direction facing the camera 100 along the flow guide 230. In this case, washer fluid pressure may be increased due to air discharged from the air discharge part. More preferably, the predetermined angle may vary depending on a spraying range and a spraying amount. Furthermore, the cover part 250 may be disposed to form the same angle as that of the flow guide 230.

Here, the flow guide 230 and the cover part 250 are configured to extend in the direction facing the camera 100, and extended lengths thereof may be different from each other. More preferably, washer fluid discharged from the washer fluid discharge part may have a predetermined viscosity and may flow downwards along the flow guide 230 due to gravity in the direction facing the camera 100. Accordingly, the flow guide 230 may extend farther in the direction facing the camera 100 than the cover part 250.

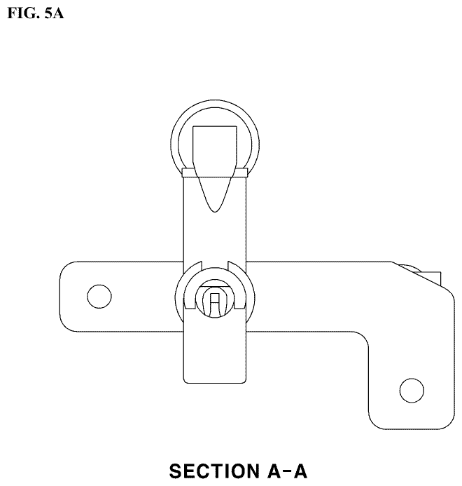

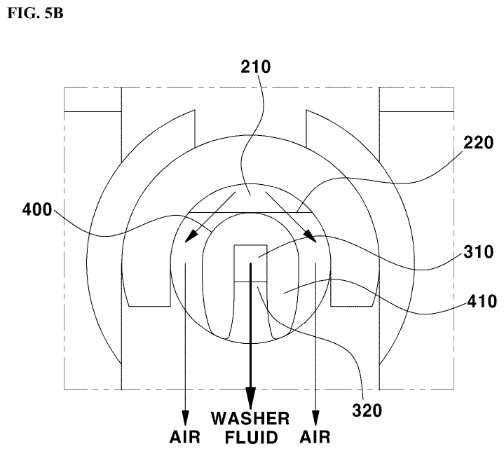

FIG. 5A is a cross-sectional view of a portion A-A of the camera-integrated spray nozzle, and FIG. 5B is an enlarged view of the air discharge part and the washer fluid discharge part.

According to the embodiment of the present disclosure, in the area of the guide groove 260 of the first flow path 210, the flange 330 of the body 300 is inserted into the guide groove 260 of the housing 200. As a result, air introduced from the air connector 600 may be discharged only to the air discharge part located on the upper side of the discharge guide 410.

More preferably, air introduced into the air connector 600 may flow in the height direction perpendicular to the discharge guide 410 and may be discharged to the air discharge part. Air discharged from the air discharge part may flow along upper opposite sides of the discharge guide 410 from the upper side to the lower side of the discharge guide 410. More preferably, air flowing along the opposite sides of the discharge guide 410 may pass through an open portion of the joint 240 and may be sprayed in the direction facing the camera 100 along the flow guide 230.

Additionally, washer fluid introduced from the washer fluid connector 500 may be discharged from the rear of the housing 200 to the front of the housing 200 along the washer fluid flow path. More preferably, the discharge guide 410 surrounds the washer fluid discharge part and may be configured to have one end open in the direction facing the camera 100. More preferably, washer fluid discharged from the washer fluid discharge part flows to the flow guide 230 through the open end of the discharge guide 410, and the washer fluid flowing to the flow guide 230 may be sprayed in the direction facing the camera 100 along the flow guide 230.

In addition, according to another embodiment of the present disclosure, the cross section of the discharge guide 410 facing the cover part 250 may be formed to have the same angle as that of the cover part 250 and may be configured to contact the cover part 250. In this case, washer fluid discharged from the washer fluid discharge part may contact the cover part 250 and may flow toward the flow guide 230.

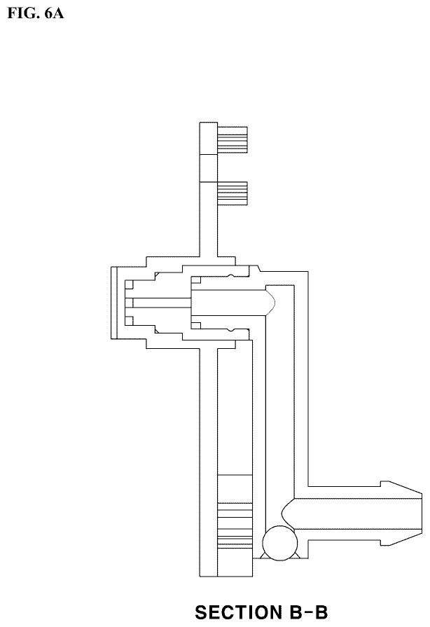

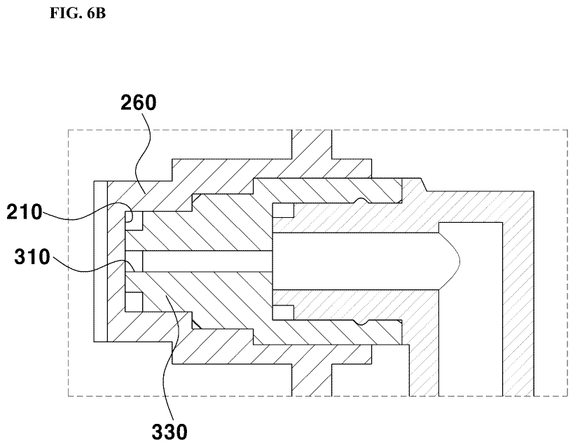

FIG. 6A is a cross-sectional view of a portion B-B shown in FIG. 4, and FIG. 6B is an enlarged view showing a state in which the housing 200, the body 300, and the washer fluid connector 500 are coupled to each other.

According to the embodiment of the present disclosure, the flange 330 of the body 300 is inserted into the guide groove 260 of the housing 200 from the rear of the housing 200 toward the front of the housing 200. The washer fluid connector 500 may be inserted into the washer fluid slot of the body 300 in the same direction as a direction in which the flange 330 of the body 300 is inserted into the guide groove 260. Through this structural configuration, the guide groove 260, the body 300, and the washer fluid connector 500 may be located on the same straight line.

In addition, as shown in FIG. 6B, the area of the guide groove 260 in the air flow path may be closed by insertion of the body 300, and air may flow into a space of the air flow path that is not in contact with the body 300. More preferably, the space through which air flows may vary depending on an extension length of the discharge guide 410 in a direction in which the body 300 is inserted into the housing 200.

Further, a linear fluid connection may be made from the end of the washer fluid connector 500 to the washer fluid discharge part. Furthermore, a cross-sectional area of the washer fluid connector 500 may be larger than a cross-sectional area of the washer fluid flow path. More preferably, due to a difference in cross-sectional area between the washer fluid connector 500 and the washer fluid flow path, fluid velocity may change when washer fluid flows from the washer fluid connector 500 to the washer fluid flow path. More preferably, in the case of the same flow rate, fluid velocity may be increased when a cross-sectional area becomes relatively narrow (flow rate=cross-sectional area×velocity).

That is, when washer fluid flows from the washer fluid connector 500 to the washer fluid flow path, the cross-sectional area of the washer fluid flow path becomes relatively small, thereby increasing the speed of the washer fluid.

Additionally, the washer fluid connector 500 may be inserted into the washer fluid slot, and a sealing part may be inserted between the washer fluid connector 500 and the washer fluid slot to prevent leakage of the washer fluid.

As is apparent from the above description, the present disclosure may achieve the following effects through the above-described configuration, combination, and usage relationship.

First, washer fluid and air are simultaneously sprayed, thereby having an effect of reliably removing foreign substances from the surface of a sensor.

Second, since washer fluid and air are simultaneously sprayed, it is possible to remove foreign substances with a smaller amount of washer fluid than a case in which foreign substances are removed only with washer fluid, thereby having an effect of reducing a usage amount of washer fluid.

The present disclosure has been described in detail with reference to preferred embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A camera-integrated spray nozzle comprising:
a camera;
a housing spaced apart from the camera, the housing comprising a first flow path configured to allow air to flow therethrough;
a body inserted into the housing, the body comprising a second flow path configured to allow washer fluid to flow therethrough; and
a discharge unit located at an end of the body,
wherein the discharge unit comprises:
a flow guide located at the housing and configured to determine a flow direction of the washer fluid and the air;
a discharge guide configured to surround a discharge part of the second flow path; and
a cover part located at the housing and configured to surround a discharge part of the first flow path and the discharge part of the second flow path.

2. The camera-integrated spray nozzle of claim 1, wherein the discharge guide has one open end facing the camera.

3. The camera-integrated spray nozzle of claim 1, further comprising a washer fluid connector coupled to the body and fluidly connected to the second flow path.

4. The camera-integrated spray nozzle of claim 1, wherein the first flow path and the second flow path are disposed perpendicular to each other.

5. The camera-integrated spray nozzle of claim 1, wherein the discharge part of the first flow path is disposed at a position facing the camera.

6. The camera-integrated spray nozzle of claim 5, wherein the air discharged to the discharge part of the first flow path flows along an outer surface of the discharge guide.

7. The camera-integrated spray nozzle of claim 1, further comprising an air connector coupled to the housing and fluidly connected to the first flow path.

8. The camera-integrated spray nozzle of claim 1, further comprising:
a flange located on the body; and
a guide groove formed in an inside surface of the housing and configured to allow the flange to be inserted thereinto.

9. The camera-integrated spray nozzle of claim 1, wherein the housing having the discharge unit located therein comprises a joint formed to extend along the second flow path, wherein the joint has one open end facing the camera.

10. The camera-integrated spray nozzle of claim 9, wherein the flow guide and the cover part are located at the joint so as to face the camera.

11. The camera-integrated spray nozzle of claim 9, wherein the flow guide and the cover part are each configured to have an inclination identical to an inclination of a shape of an end of the joint.

12. The camera-integrated spray nozzle of claim 1, wherein the discharge guide has an end located in contact with the housing.

13. The camera-integrated spray nozzle of claim 12, wherein the discharge part of the first flow path is located in a space defined between the discharge guide and the housing.
